(19) United States
(12) Patent Application Publication
(10) Pub. No.: US 2024/0191725 A1
(43) Pub. Date: Jun. 13, 2024

(54) Compensation Liquid for a Compressed Gas Energy Storage System

(71) Applicant: Hydrostor Inc., Toronto (CA)

(72) Inventors: Davin Young, Toronto, Ontario (CA); Andrew McGillis, Toronto (CA); Curtis Vanwalleghem, Toronto, Ontario (CA)

(21) Appl. No.: 18/286,054

(22) PCT Filed: Apr. 1, 2022
(86) PCT No.: PCT/CA2022/050503

§ 371 Date: Oct. 6, 2023

Related U.S. Application Data
(60) Provisional application No. 63/173,049, filed on Apr. 9, 2021.

(51) Int. Cl. F15B 1/027; F15B 1/04

(52) U.S. Cl. CPC F15B 1/027; F15B 1/04

(57) ABSTRACT

A hydrostatically compensated, compressed gas energy storage system can include an accumulator containing a layer of compressed gas at between about 20 bar and about 90 bar above a layer of compensation liquid that has a density of at least 1500 kg/m3. A compressor and expander subsystem may be configured to selectably convey compressed gas into the accumulator and to extract gas from the accumulator. The system may be operable in at least a charging mode in which the compressor and expander subsystem conveys gas into the layer of compressed gas thereby displacing a corresponding volume of compensation liquid from the layer of compensation liquid within the accumulator out of the accumulator via the compensation liquid flow path thereby maintaining the layer of compressed gas at substantially the accumulator pressure during the charging mode.

### CROSS-REFERENCE TO RELATED APPLICATION

This application claims the benefit of co-pending, U.S. provisional application No. 63/173,049, filed Apr. 9, 2021 and entitled Compensation Liquid For A Compressed Gas Energy Storage System, the entirety of which is incorporated herein by reference.

### FIELD

The present disclosure relates generally to compressed gas energy storage, and more particularly to a compressed gas energy storage system such as, for example, one including a hydrostatically compensated, compressed air energy storage accumulator located underground, the use thereof.

### INTRODUCTION

Electricity storage is highly sought after, in view of the cost disparities incurred when consuming electrical energy from a power grid during peak usage periods, as compared to low usage periods. The addition of renewable energy sources, being inherently of a discontinuous or intermittent supply nature, increases the demand for affordable electrical energy storage worldwide.

Thus there exists a need for effectively storing the electrical energy produced at a power grid or a renewable source during a non-peak period and providing it to the grid upon demand. Additionally, to the extent that the infrastructural preparation costs and the environmental impact from implementing such infrastructure are minimized, the utility and desirability of a given solution is enhanced.

Furthermore, as grids transform and operators look to storage in addition to renewables to provide power and remove traditional forms of generation that also provide grid stability, such as voltage support, a storage method that offers inertia based synchronous storage is highly desirable.

U.S. Pat. No. 3,996,741 discloses a system and apparatus for the storage of energy generated by natural elements. Energy from natural elements such as from the sun, wind, tide, waves, and the like, is converted into potential energy in the form of air under pressure which is stored in a large, subterranean cell. Machines of known types such as windmills are driven by natural elements to operate air compressors. Air compressors pump the air under pressure to the storage cell. Air entering the storage cell displaces water from the cell which returns to a water reservoir as an ocean or a lake. Water locks the air in the storage cell. The stored compressed air is available upon demand to perform a work function as driving an air turbine to operate an electric generator.

International patent publication no. WO2013/131202 discloses a compressed air energy storage system comprising a pressure accumulator for gas to be stored under pressure, and a heat accumulator for storing the compression heat that has accumulated during charging of the pressure accumulator, wherein the heat accumulator is arranged ready for use in an overpressure zone. Said arrangement enables a structurally simple heat accumulator to be provided, since said heat accumulator is not loaded by the pressure of the gas passing therethrough.

US patent publication no. US2013/0061591 discloses, during an adiabatic compressed air energy storage (ACAES) system's operation, energy imbalances may arise between thermal energy storage (TES) in the system and the thermal energy required to raise the temperature of a given volume of compressed air to a desired turbine entry temperature after the air is discharged from compressed air storage of the ACAES system. To redress this energy imbalance it is proposed to selectively supply additional thermal energy to the given volume of compressed air after it received thermal energy from the TES and before it expands through the turbine. The additional thermal energy is supplied from an external source, i.e. fuel burnt in a combustor. The amount of thermal energy added to the given volume of compressed air after it received thermal energy from the TES is much smaller than the amount of useful work obtained from the given volume of compressed air by the turbine.

US patent publication no. US 2003/0021631 discloses a compressed gas storage tank 10 that utilizes a rock-bed cavity 11 in which a bentonite slurry is fed into an underground cavity 11 formed in a rock-bed, a forcibly fed compressed gas is stored in said rock-bed cavity in a state in which the compressed gas is loaded with a pressure load of the bentonite slurry from the underside of the compressed gas, the bentonite slurry in the rock-bed cavity 11 is of a dual layer structure consisting of an upper layer composed of a light bentonite slurry 30 mixed with a filling-up material invading into and filling up a void and a crack formed in an inner wall surface and a lower layer composed of a heavy bentonite slurry 13 mixed with a high specific gravity fine powder as a load condition material. The filling-up effect of the bentonite slurry secures sufficient liquid-tightness and air-tightness in the ceiling part of the rock-bed cavity, making it possible to efficiently and economically store compressed gasses such as compressed air or natural gas without allowing them to escape

International patent publication no. WO 2018/141057 discloses a compressed gas energy storage system that may include an accumulator for containing a layer of compressed gas atop a layer of liquid. A gas conduit may have an upper end in communication with a gas compressor/expander subsystem and a lower end in communication with accumulator interior for conveying compressed gas into the compressed gas layer of the accumulator when in use. A shaft may have an interior for containing a quantity of a liquid and may be fluidly connectable to a liquid source/sink via a liquid supply conduit. A partition may cover may separate the accumulator interior from the shaft interior. An internal accumulator force may act on the inner surface of the partition and the liquid within the shaft may exert an external counter force on the outer surface of the partition, whereby a partition force acting on the partition is less than the accumulator force.

### SUMMARY OF THE INVENTION

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

Energy produced by some types of energy sources, such as windmills, solar panels and the like may tend to be produced during certain periods (for example when it is windy, or sunny respectively), and not produced during other periods (if it is not windy, or at night, etc.). However, the demand for energy may not always match the production periods, and it may be useful to store the energy for use at a later time. Similarly, it may be helpful to store energy generated using conventional power generators (coal, gas and/or nuclear power plants for example) to help facilitate storage of energy generated during non-peak periods (e.g. periods when electricity supply could be greater than demand and/or when the cost of electricity is relatively high) and allow that energy to be utilized during peak periods (e.g. when the demand for electricity may be equal to or greater than the supply, and/or when the cost of electricity is relatively high).

As described herein, compressing and storing a gas (such as air), using a suitable compressed gas energy storage system, is one way of storing energy for later use. For example, during non-peak times, energy (i.e. electricity) can be used to drive compressors and compress a volume of gas to a desired, relatively high pressure for storage. The gas can then be stored at the relatively high pressure inside any suitable container or vessel, such as a suitable accumulator. To extract the stored energy, the pressurized gas can be released from the accumulator and used to drive any suitable expander apparatus or the like, and ultimately to be used to drive a generator or the like to produce electricity. The amount of energy that can be stored in a given compressed gas energy storage system may be related to the pressure at which the gas is compressed/stored, with higher pressure storage generally facilitating a higher energy storage for a given accumulator/system volume.

In systems where a compensation liquid is used to help regulate the gas pressure within the accumulator, such as in a hydrostatically compensated compressed gas energy storage system, the operating parameters of the system can be influenced by pressure that can be exerted by the compensation liquid, and more specifically by the hydrostatic pressure of the compensation liquid at the depth/location of the accumulator. Without the use of pumps or other pressurization mechanisms to pressurize compensation liquid, the hydrostatic pressure of the compensation liquid is generally a function of the depth of the liquid (e.g. or the height of the liquid column that is above the accumulator or other measurement location). For systems in which the accumulator is partially, or entirely located below ground, the depth of the accumulator below the surface of the ground (and relative to the upper end of any associated compensation liquid shaft) can affect the hydrostatic pressure at the accumulator—and therefore affect operating gas pressure/accumulator pressure of the system. For example, the hydrostatic pressure at a depth of 200 m within a compensation liquid shaft will be less than the hydrostatic pressure at a depth of 600 m within the same shaft.

Another factor that can affect the hydrostatic pressure within a compensation liquid shaft/column is the nature of the compensation liquid that is used, and notably its density. A denser liquid will have more mass for a given volume and will exert a higher hydrostatic pressure at a given depth than a liquid that is less dense.

In some examples of a hydrostatically compensated compressed gas energy storage system it may be desirable to operate the system at a relatively high gas or accumulator pressure, such as a pressure of approximately 60 bar, which could be achieved by using water as the compensation liquid and positioning the accumulator at depth of approximately 600 m. However, positioning the accumulator at a depth of 600 m may not be practical in all circumstances. For example, ground and/or rock conditions in the desired system location or other such factors may not accommodate the positioning of the accumulator at the desired depth, and may limit it to a depth of 400 m (for example).

If the water used as a compensation liquid in such examples, the operating pressures of the system may be limited to approximately 40 bar, rather than the preferred 60 bar. In other circumstances it may be possible to provide an accumulator at a given depth, but there may be some physical and/or economic limitations on the size of accumulator that can be provided, which can limit the amount of air/gas that can be stored in the accumulator (at a given operating pressure) which can in turn limit the amount of energy that can be stored using the system. Increasing the operating pressure of such systems, even if operating at a given, desirable accumulator depth, by increasing the hydrostatic pressure that is applied via the compensation liquid may help increase the energy density of the accumulator (e.g. more gas can be stored within a given accumulator volume when it is stored at a relatively higher pressure). Using a relatively denser compensation liquid is one way to increase the hydrostatic pressure within the hydraulic compensation system for a given accumulator size and depth. It may be possible, in some examples of the systems described herein, to retrofit an existing system to operate at a higher energy density by replacing some or all of its initial compensation liquid with a new, higher density compensation liquid.

One example of a compensation liquid that is more dense than water (either fresh or salt water) and that can be suitable for use with the hydrostatically compensated compressed gas energy storage systems described herein is a water-based slurry, which is understood herein to refer to a mixture of solids/solid particles that are denser than water and that are suspended in the water. In such examples, the mass of the suspended solids contributes to the higher density of the slurry and the concentration or amount of suspended solids can be modified in different examples of the slurries described herein to provide slurries with different densities.

In accordance with one broad aspect of the teachings described herein, a hydrostatically compensated, compressed gas energy storage system may include an accumulator disposed underground and having an interior for containing a layer of compressed gas above a layer of compensation liquid. The layer of compressed gas may be at an accumulator pressure that is between about 20 bar and about 90 bar and the compensation liquid may have a density of at least 1500 kg/m3. A compressor and expander subsystem may be in fluid communication with the accumulator interior via a gas flow path and may be configured to selectably convey compressed gas into the accumulator and to extract gas from the accumulator. A compensation liquid reservoir may be spaced apart from the accumulator and a compensation liquid flow path may extend between the compensation liquid reservoir and the layer of compensation liquid. The system may be operable in at least a charging mode in which the compressor and expander subsystem conveys gas into the layer of compressed gas thereby displacing a corresponding volume of compensation liquid from the layer of compensation liquid within the accumulator out of the accumulator via the compensation liquid flow path thereby maintaining the layer of compressed gas at substantially the accumulator pressure during the charging mode.

The system may be operable in a discharging mode in which the compressor and expander subsystem extracts gas from the layer of compressed gas as a corresponding volume of compensation liquid flows from compensation liquid flow path into the layer of compensation liquid within the accumulator thereby maintaining the layer of compressed gas at substantially the accumulator pressure during the discharging mode.

The compensation liquid may be a slurry having solid particles suspended in water.

The solid particles may include particles formed from at least one of clay, ore, sand, rocks, magnetite, limestone, iron ore, copper concentrate.

The solid particles may include at least one of magnetite, limestone, iron ore, and copper concentrate.

At least 90% of the solid particles may remain in suspension in the water for at least 12 hours.

At least 90% of the solid particles may remain in suspension in the water for at least 48 hours.

The compensation liquid may be less than 3000 kg/m3.

The compensation liquid density may be less than 2600 kg/m3.

The compensation liquid density may be less than 2400 kg/m3.

An agitating system may be configured to agitate the compensation liquid within the compensation liquid reservoir to help keep the solid particles suspended in the water.

An agitating system may be configured to agitate the compensation liquid within the accumulator to help keep the solid particles suspended in the water.

The accumulator pressure may be at least 50 bar.

The accumulator may be disposed at an accumulator depth that is between about 200 m and about 700 m.

The accumulator depth may be less than 500 m and the accumulator pressure may be more than 55 bar.

The compensation liquid flow path may include a shaft having a lower end adjacent the accumulator, an upper end spaced apart from the lower end, and a shaft sidewall extending upwardly from the lower end to the upper end and at least partially bounding a shaft interior containing a quantity of the compensation liquid. The shaft interior may be fluidly connected to the compensation liquid reservoir and a partition may separate an interior of the accumulator from the shaft interior. The partition may have an outer surface in contact with the quantity of compensation liquid within the shaft interior and an opposing inner surface in contact with the layer of compressed gas and the layer of compensation liquid. At least one of the layer of compressed gas and the layer of compensation liquid bears against and exerts an internal accumulator force on the inner surface of the partition and the quantity of liquid within the shaft bears against and exerts an external hydrostatic counter force on the outer surface of the partition, so that a partition force acting on the partition while the compressed gas energy storage system is in use is a difference between the accumulator force and the hydrostatic counter force and is less than the accumulator force.

The shaft interior may be fluidly connected to the layer of compensation liquid by a liquid supply conduit so that the compensation liquid can flow between the shaft interior and the layer of liquid in the accumulator in response to changes in the pressure of the layer of compressed gas.

The liquid supply conduit may pass thorough the partition or may pass beneath the partition.

The liquid supply conduit may extend between a first end that is proximate the outer surface of the partition and is in fluid communication with the shaft and a second end that is in communication with the layer of compensation liquid and remains fluidly isolated from the layer of gas when the compressed gas energy storage system is in use.

The gas flow path may include a gas supply conduit configured to convey compressed gas between the layer of compressed gas and the compressor and expander subsystem. At least a portion of an outer surface of the gas supply conduit may be in contact with the compensation liquid in the compensation liquid flow path.

The gas supply conduit may pass through the partition.

The gas flow path may include a gas supply conduit that is external to the liquid flow path and may be configured to convey compressed gas between the layer of compressed gas and the compressor and expander subsystem.

### BRIEF DESCRIPTION OF THE DRAWINGS

The drawings included herewith are for illustrating various examples of articles, methods, and apparatuses of the teaching of the present specification and are not intended to limit the scope of what is taught in any way.

FIG. 1 is a schematic representation of one example of a hydrostatically compressed gas energy storage system;

FIG. 2 is a schematic representation of a portion of the system of FIG. 1;

FIG. 3 is a schematic representation of another example of a hydrostatically compressed gas energy storage system; and

FIG. 4 is a schematic representation of another example of a hydrostatically compressed gas energy storage system.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

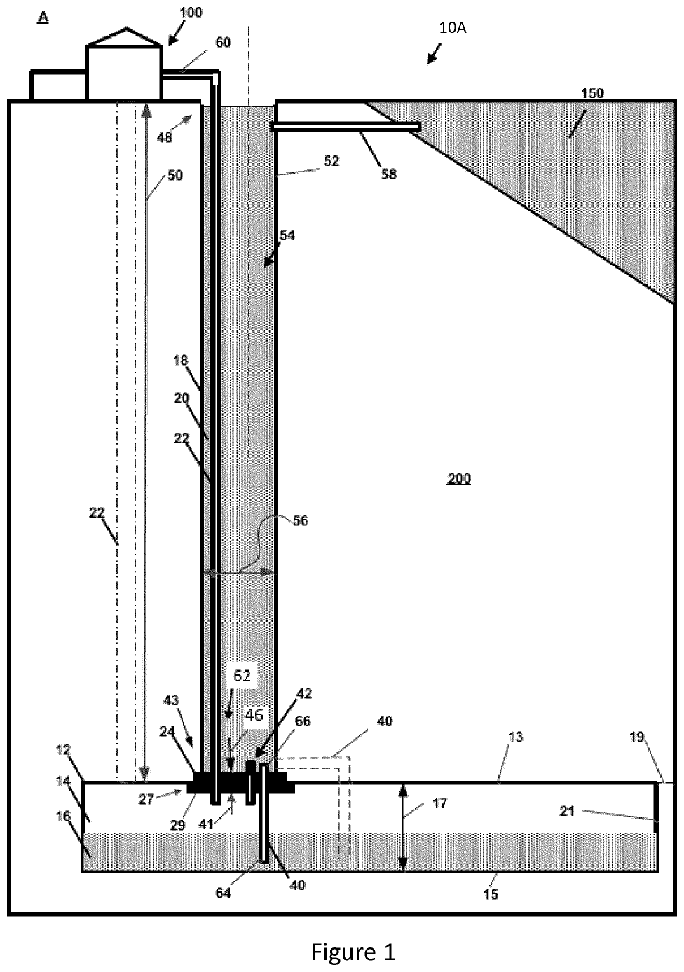

Referring to FIG. 1 one example of a hydrostatically compensated compressed gas energy storage system 10A, that can be used to compress, store and release a gas, includes an accumulator 12 that is located underground (although in another embodiment the accumulator may be located above ground). In this example, the accumulator 12 serves as a chamber for holding both compressed gas and a compensation liquid (such as water or a slurry as described herein) and can include any suitable type of pressure vessel or tank, or as in this example can be an underground cave or chamber that is within ground 200. Optionally, the accumulator 12 may be lined, for example using concrete, metal, plastic and combinations thereof or the like, to help make it substantially gas and/or liquid impermeable so as to help to prevent unwanted egress of gas or liquid from within its interior. In another embodiment, the accumulator is preferably impermeable to gas and or liquid without requiring a lining.

The accumulator 12 may have any suitable configuration, and in this example, includes an upper wall 13 and an opposing lower wall 15 that are separated from each other by an accumulator height 17. The upper and lower walls 13 and 15 may be of any suitable configuration, including curved, arcuate, angled, and the like, and in the illustrated example are shown as generally planar surfaces, that are generally parallel to a horizontal reference plane 19. The accumulator 12 also has an accumulator width (not shown—measured into the page as illustrated in FIG. 1). The upper and lower walls 13 and 15, along with one or more sidewalls 21 at least partially define an interior of the accumulator 12, that has an accumulator volume.

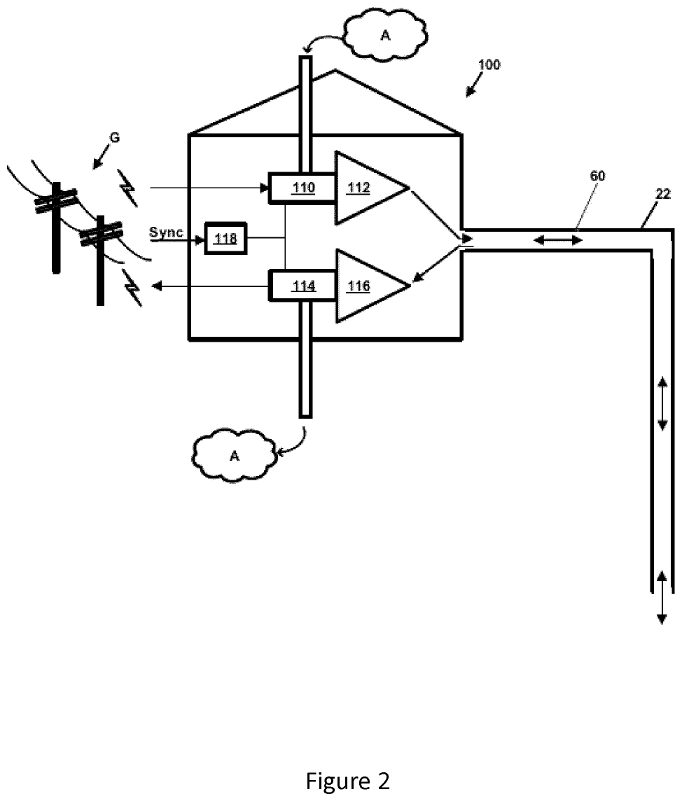

The accumulator 12 in a given embodiment of the system 10A can be sized based on a variety of factors (e.g. the quantity of gas to be stored, the available space in a given location, etc.) and may, in some examples may be between about 1,000 m³ and about 2,000,000 m³ or more. For example, in this embodiment the accumulator 12 contains a layer of stored compressed gas 14 atop a layer of compensation liquid 16, and its volume (and thus capacity) can be selected based on the quantity of gas 14 to be stored, the duration of storage required for system 10A, the desired accumulator pressure, features of the surrounding ground/rocks, compensation liquid composition and other suitable factors which may be related to the capacity or other features of a suitable power source and/or power load with which the system 10A is to be associated. The power source/load may be, in some examples, a power grid G (FIG. 2), a power source (including renewable and optionally non-renewable sources) and the like. Furthermore, the power source and power load may be completely independent of each other (e.g. the power source may be a renewable source, and the power load may be the grid).

Preferably, the accumulator 12 may be positioned below ground or underwater, but alternatively may be at least partially above ground. Positioning the accumulator 12 within the ground 200, as shown, may allow the weight of the ground/soil to help backstop/buttress the walls 13, 15 and 21 of the accumulator 12, and help resist any outwardly acting forces that are exerted on the walls 13, 15 and 21 of the interior 23 of the accumulator. Its depth in the ground, shown as an accumulator depth 50 in FIG. 1, is established according to the pressures at which the compression/expansion equipment to be used is most efficiently operated as this depth 50 and influence the hydrostatic pressure exerted by the compensation liquid, as well as the geology in the surrounding area and the like. The depth 50 may be between about 200 m and about 700 m, and may be between 400 m and 600 m and may be at least 500 m in some examples.

The gas that is to be compressed and stored in the accumulator 12 may be any suitable gas, including, but not limited to, air, nitrogen, noble gases and combinations thereof and the like. Using air may be preferable in some embodiments as a desired quantity of air may be drawn into the system from the surrounding, ambient environment and gas/air that is released from within the accumulator 12 can similarly be vented to the ambient environment, optionally without requiring further treatment. In this embodiment, the compressed gas 14 is compressed atmospheric air, and the liquid is a slurry of water with suspended solids.

Optionally, to help provide access to the interior of the accumulator 12, for example for use during construction of the accumulator and/or to permit access for inspection and/or maintenance, the accumulator 12 may include at least one opening that can be sealed in a generally air/gas tight manner when the system 10A is in use. In this example, the accumulator 12 includes a primary opening 27 that is provided in the upper wall 13. The primary opening 27 may be any suitable size and may have a cross-sectional area that is adequate based on the specific requirements of a given embodiment of the system 10A. In one embodiment the cross-sectional area is between about 0.75 m2 and about 80 m2 but may be larger or smaller in a given embodiment.

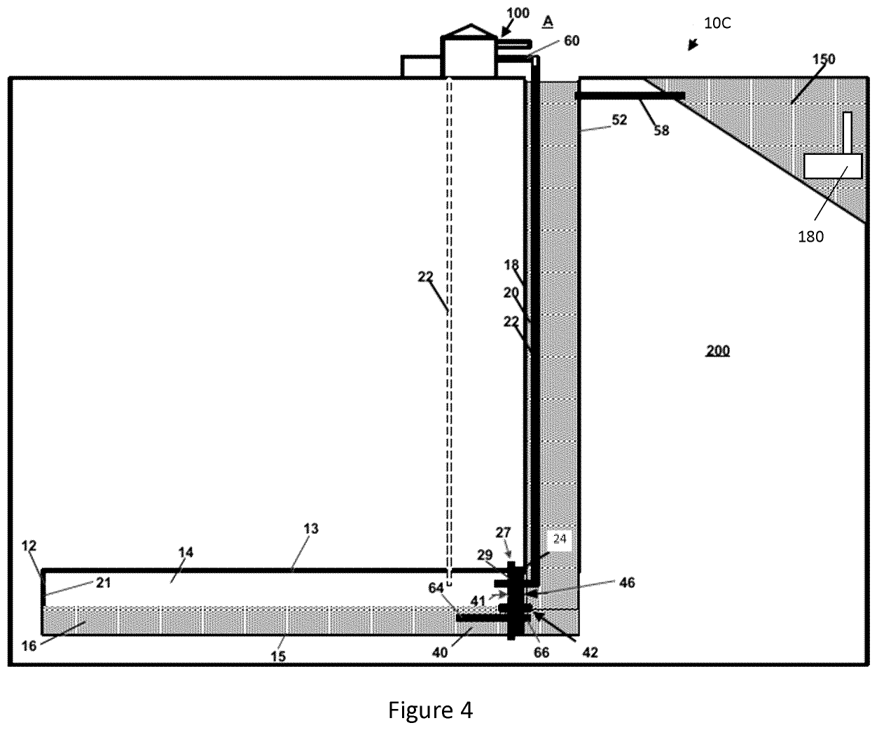

When the system 10A is in use, the primary opening 27 may be sealed using any suitable type of partition that can function as a suitable sealing member. In the embodiment of FIG. 1, the system 10A includes a partition in the form of a bulkhead 24 that covers the primary opening 27 and that is arranged generally horizontally (as illustrated in FIG. 1). In other examples, such as a hydrostatically compensated compressed gas energy storage system 10C that is shown in FIG. 4, the bulkhead 24 can be oriented vertically such that it seals an opening in a sidewall of the accumulator 12. Other examples of suitable partitions are described in PCT/CA2018/050112 and PCT/CA2018/050282, which are incorporated herein by reference.

When the bulkhead 24 is in place, as shown in FIG. 1, it can be secured to, and preferably sealed with the accumulator wall, in this embodiment upper wall 13, using any suitable mechanism to help seal and enclose the interior 23. In this embodiment the shaft 18 is illustrated schematically as a generally linear, vertical column. Alternatively, the shaft 18 may be a generally linear inclined shaft or preferably may be a curved and/or generally spiral/helical type configuration and which may be referred to as a shaft or generally as a decline. Some embodiments may include a generally spiralling configured decline that winds from an upper end to a lower end and can have an analogous function and attributes as the vertical shaft 18 of FIG. 1 despite having a different geometrical configuration. Discussions of the shaft/decline 18 and its purposes in one embodiment can be applied to other embodiments described herein.

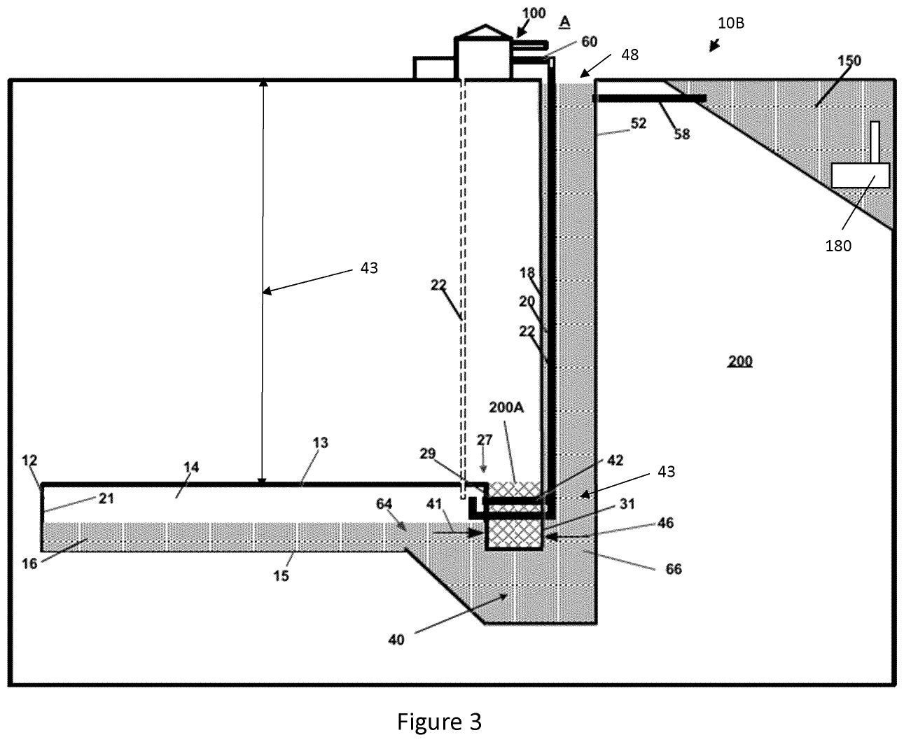

In the embodiment of FIG. 1, the primary opening 27 is provided in the upper surface 13 of the accumulator 12. Alternatively, in other embodiments the primary opening 27 and any associated partition may be provided in different portions of the accumulator 12, including, for example, on a sidewall (such as sidewall 21 as shown in FIGS. 3 and 4), in a lower surface (such as lower surface 15) or other suitable location. The location of the primary opening 27, and the associated partition, can be selected based on a variety of factors including, for example, the geology and underground conditions, the availability of existing structures (e.g. if the system 10A is being retrofit into some existing spaces, such as mines, quarries, storage facilities and the like), operating pressures, shaft configurations and the like. For example, some aspects of the systems 10A described herein may be retrofit into pre-existing underground chambers, which may have been constructed with openings in their sidewalls, floors and the like.

When the primary opening 27 extends along the sidewall 21 of the accumulator 12 as shown in the embodiment of FIG. 3, it may be positioned such that is contacted by only the gas layer 14 (i.e. toward the top of the accumulator 12), contacted by only the layer of compensation liquid 16 (i.e. submerged within the layer of compensation liquid 16 and toward the bottom of the accumulator) and/or by a combination of both the gas layer 14 and the layer of compensation liquid 16 (i.e. partially submerged and partially non-submerged in the liquid). The specific position of the free surface of the layer of compensation liquid 16 (i.e. the interface between the layer of compensation liquid 16 and the gas layer 14) may change while the system 10 is in use as gas is forced into (causing the liquid layer to drop) and/or withdrawn from the accumulator (allowing the liquid level to rise).

When the accumulator 12 is in use, at least one of the pressurized gas layer 14 and the layer of compensation liquid 16 may contact and exert pressure on the inner-surface 29 of the bulkhead 24, which will result in a generally outwardly, (upwardly in this embodiment) acting internal accumulator force, represented by arrow 41 in FIG. 1, acting on the bulkhead 24.

In the present embodiment, the system 10 includes a shaft 18 that is configured so its lower end 43 is in communication with the opening 27 of the accumulator 12, and its upper end 48 that is spaced apart from the lower end 43 by the accumulator depth 50 that also coincides with the shaft height in this example. At least one sidewall 52 extends from the lower end 43 to the upper end 48, and at least partially defines a shaft interior 54 having a volume. In this embodiment, the shaft 18 is generally linear and extends along a generally vertical shaft axis, but may have other configurations, such as a linear, curved, or helical decline, in other embodiments. The upper end 48 of the shaft 18 may be open to the atmosphere A, as shown, or may be capped, enclosed or otherwise sealed. In this embodiment, shaft 18 is generally cylindrical with a diameter 56 of about 3 metres, and in other embodiments the diameter 56 may be between about 2 m and about 15 m or more, or may be between about 5 m and 12 m, or between about 2 m and about 5 m. In such arrangements, the interior 52 of the shaft 18 may be able to accommodate about 1,000-150,000 m³ or more of a suitable compensation liquid.

In this arrangement, the bulkhead 24 is positioned at the interface between the shaft 18 and the accumulator 12, and the outer surface 31 (or at least a portion thereof) closes and seals the lower end 43 of the shaft 18. The bulkhead may include a variety of other elements to help facilitate operation of the system 10A, including a gas release valve illustrated schematically using reference character 42. Preferably, the other boundaries of the shaft 18 (e.g. the sidewall 52) are generally liquid impermeable, such that the interior 54 can be filled with, and can generally retain a quantity of a suitable compensation liquid 20. The compensation liquid 20 for a given system 10 can be chosen based on the features of the system, including the accumulator size, the accumulator depth 50 and its desired system operating/accumulator pressure. In some examples, the compensation liquid can be water, while in other examples the compensation liquid can be a slurry that has a higher density than water, which may help facilitate operating a given system at a higher accumulator pressure than if using water as the compensation liquid.

A compensation liquid supply/replenishment conduit 58 can provide fluid communication between the interior 54 of the shaft 18 and a compensation liquid source/sink 150 to allow compensation liquid to flow into or out of the interior of the shaft 18 as required when the system 10 is in operational modes. Optionally, a flow control apparatus may be provided in the compensation liquid supply/replenishment conduit 58. The flow control apparatus may include a valve, sluice gate, or other suitable mechanism. The flow control apparatus can be open while the system 10 is in operational modes to help facilitate the desired flow of compensation liquid between the shaft 18 and the compensation liquid source/sink 150. Optionally, the flow control apparatus can be closed to fluidly isolate the shaft 18 and the compensation liquid source/sink 150 if desired. For example, the flow control apparatus may be closed to help facilitate draining the interior 54 of the shaft 18 for inspection, maintenance or the like. One or more suitable pumps or other flow equipment may also be provided in this flow path if desired. In the illustrated examples, a compensation liquid flow path is defined between the compensation liquid source/sink 150 and the layer of compensation liquid 16 within the accumulator, and this path can include the shaft 18, compensation liquid supply conduit 40, supply/replenishment conduit 58 and the compensation liquid source/sink 150, along with other suitable conduits or members. Compensation liquid can flow through this flow path when the system is in the charging and discharging modes.

The compensation liquid source/sink 150 may be of any suitable nature and configuration for a given system and for a given compensation liquid (e.g. water, slurry or other type of liquid). The compensation liquid source/sink 150 may include, for example, a generally open pond or reservoir (which may be configured to hold, water, slurry or the like), a purposely built reservoir, a storage tank, a water tower, a connection to a municipal water supply or reservoir and/or a natural body of water such as a lake, river or ocean, groundwater, or an aquifer. In the illustrated example, the compensation liquid source/sink 150 is illustrated as an open reservoir that can contain the desired compensation slurry. Optionally, the compensation liquid source/sink 150 may include any suitable mixing, stirring and/or agitating system (illustrated schematically in FIGS. 3 and 4 using character 180) that can help keep the solid particles suspended in the carrier liquid, which can help keep the slurry in its desired state. This may include a mechanical mixing arm or structure that can include any suitable motor or power source and combination of physical engagement or mixing member that can contact and mix the compensation liquid. The agitating system could also include a sparger, bubbler or other type of mixing mechanism. The system 10A may also be arranged so that additional solid material may be introduced into the compensation liquid source/sink 150 to be mixed into the slurry, for example to alter its density while the system is in use (such as to account for liquid loss, evaporation, different operating pressure requirements or the like).

Allowing the compensation liquid to flow through the conduit 58 may help ensure that a sufficient quantity of compensation liquid 20 may be maintained within shaft 18 and that excess compensation liquid 20 can be drained from shaft 18. The conduit 58 may be connected to the shaft 18 at any suitable location, and preferably is connected toward the upper end 48. Preferably, the conduit 58 can be positioned and configured such that compensation liquid will flow from the source/sink 150 to the shaft 18 via gravity, and need not include external, powered pumps or other conveying apparatus. Although the conduit 58 is depicted in the figures as horizontal, it may be non-horizontal.

In this embodiment, the system 10A includes a gas flow path that provides fluid communication between the compressor/expander subsystem 100 and the accumulator 12. The gas flow path may include any suitable number of conduits, passages, hoses, pipes and the like and any suitable equipment may be provided in (i.e. in air flow communication with) the gas flow path, including, compressors, expanders, heat exchangers, valves, sensors, flow meters and the like. Referring to the example of FIG. 1, in this example the gas flow path includes a gas supply conduit 22 that is provided to convey compressed air between the compressed gas layer 14 and the compressor/expander subsystem 100, which can convert the potential energy of compressed air to and from electricity. Similarly, a liquid supply conduit 40 is configured to convey water between the layer of compensation liquid 16 and the compensation liquid 20 in shaft 18. Each conduit 22 and 40 may be formed from any suitable material, including metal, the surrounding rock, plastic and the like.

In this example, the gas conduit 22 has an upper end 60 that is connected to the compressor/expander subsystem 100, and a lower end 62 that is in communication with the compressed gas layer 14. The gas conduit 22 is, in this example, positioned inside and extends within the shaft 18 whereby at least a portion of the outer surface of the gas supply conduit 22 is in contact with the compensation liquid that is within the shaft 18, and passes through the bulkhead 24 to reach the compressed gas layer 14. Positioning the gas conduit 22 within the shaft 18, and thus exposing at least some of its outer surface to the compensation liquid, may eliminate the need to bore a second shaft and/or access path from the surface to the accumulator 12. The positioning in the current embodiment may also leave the gas conduit 22 generally exposed for inspection and maintenance, for example by using a diver or robot that can travel through the compensation liquid 20 within the shaft 18 and/or by draining some or all of the water from the shaft 18. Alternatively, as shown using dashed lines in FIG. 1 (and in the other embodiments described herein), the gas conduit 22 may be external the shaft 18 and/r or may not be in contact with the compensation liquid. Positioning the gas conduit 22 outside the shaft 18 may help facilitate remote placement of the compressor/expander subsystem 100 (i.e. it need not be proximate the shaft 18) and may not require the exterior of the gas conduit 22 (or its housing) to be submerged in the compensation liquid. This may also eliminate the need for the gas conduit 22 to pass through the partition that separates the accumulator 12 from the shaft 18.

The liquid supply conduit 40 is, in this example, configured with a lower or inner end 64 that is submerged in the layer of compensation liquid 16 while the system 10 is in use and a remote upper, or outer end 66 that is in communication with the interior 54 of the shaft 18. In this configuration, the liquid supply conduit 40 can facilitate the exchange of liquid between the layer of compensation liquid 16 and the compensation liquid 20 in the shaft 18. As illustrated in FIG. 1, the liquid supply conduit 40 can pass through the bulkhead 24 (as described herein), or alternatively, as shown using dashed lines, may be configured to provide communication between the layer of compensation liquid 16 and the compensation liquid 20, but not pass through the bulkhead 24.

In this arrangement, as more gas is transferred into the gas layer 14 during an accumulation cycle or charging mode the compensation liquid, such as a slurry or water in the layer of compensation liquid 16 can be displaced and forced upwards through the liquid supply conduit 40 into shaft 18 against the hydrostatic pressure of the compensation liquid 20 in the shaft 18. More particularly, the compensation liquid can preferably freely flow from the layer of compensation liquid 16 within the accumulator 12 and into shaft 18, and ultimately may be exchanged with the source/sink 150 of compensation liquid, via a replenishment conduit 58. Alternatively, any suitable type of flow limiting or regulating device (such as a pump, valve, orifice plate and the like) can be provided in the compensation liquid supply conduit 40. When the system is operated in a discharging mode wherein gas is removed from the gas layer 14 and used to generate energy, compensation liquid can flow from the shaft 18, through the compensation liquid supply conduit 40, into the accumulator to refill the layer of compensation liquid 16 as the gas is withdrawn. As additional compensation liquid flows into the accumulator it helps maintain the accumulator pressure, even as gas is being withdrawn. This can help ensure that the pressure of the gas being extracted remains generally constant even when different amounts of gas are left in the accumulator 12. This can help the compression and expansion subsystem to operate in its intended, and preferably relatively efficient, ranges as the gas to be expanded is at a substantially constant pressure (and temperature if a suitable thermal conditioning systems is used) throughout the discharge mode.

The flow through the replenishment conduit 58 can help ensure that a desired quantity of compensation liquid 20 may be maintained within shaft 18 as compensation liquid is flows into and out of the layer of compensation liquid 16, as excess compensation liquid 20 can be drained from and make-up compensation liquid can be supplied to the shaft 18. This arrangement can allow the pressures in the accumulator 12 and shaft 18 to at least partially, automatically re-balance as gas is forced into and released from the accumulator 12. That is, the pressure within the accumulator 12 may remain relatively constant (e.g. within about 5-10% of the desired accumulator pressure) while the system is in the charging mode, storage mode and/or discharging mode. Any given system may be configured to have a desired accumulator pressure, but generally the accumulator pressures may be at least about 10 bar and generally may be between about 10 and about 80 bar or more, and may be between about 20 bar and about 70 bar, between about 40 and about 65 bar, and optionally between about 50 and about 60 bar.

For example, in the embodiment of FIG. 1, the accumulator pressure can be a function of both the accumulator depth 50 and the compensation liquid composition. If an accumulator pressure of about 60 bar is desired, the system 10A can be configured to use water (e.g. a liquid with a density of approximately 1000 kg/m³) as a compensation liquid if the accumulator depth is about 600 m. However, if the accumulator depth 50 is less than 600 m, such as being approximately 200-250 m, then using water as a compensation liquid could limit the accumulator pressure to only about 20-25 bar. To achieve the desired 60 bar accumulator pressure the system 10A could utilize a slurry as its compensation liquid instead of water. The slurry can be configured so that it has a density that is greater than that of water, and preferably is at least 1.5, 1.6, 1.7, 1.8, 1.9. 2, 2.1, 2.2, 2.3, 2.4, 2.5, 2.6, 2.7 or more times the density of water. That is, the density of the slurry may be at least about 1500, 1600, 1700, 1800, 1900, 2000, 2100, 2200, 2300, 2400, 2500, 2600 or 2700 kg/m³. For example, if the system 10A has an accumulator depth 50 of about 200 m it could use a slurry, including solid magnetite particles suspended in water at a solids concentration such that the density of the slurry is approximately 2000 kg/m³. If, instead, the depth 50 was 250 m, the slurry could be configured so that its density is about 2400 kg/m³, which could provide an accumulator pressure of about 60 bar. Different combinations of accumulator depth 50 and compensation liquid composition can be used to provide different accumulator pressures at different accumulator depths 50.

In some embodiments, there may be practical, upper limits on the density of the compensation liquid. For example, it may be desirable for the density of the compensation liquid to be less than the average density the properties and/or characteristics of ground 200 surrounding the accumulator 12. If, for example, the average density of the ground 200/rock surrounding the accumulator 12 is about 2600 kg/m³, it may be desirable for the compensation liquid density to be less than 2600 kg/m³. If the density of the compensation liquid were greater than the density of the ground 200 it may lift/expand the ground 200 itself or otherwise have undesirable effects on the ground 200 surrounding the accumulator 12. In some systems, the upper limit for the density of the compensation liquid may be about 2.5-2.6 times the density of water, or about 2500-2600 kg/m³. This limit may be lower if the ground 200 has a lower average density.

Preferably, the lower/inner end 64 of the liquid supply conduit 40 is positioned so that it is and remains submerged in the layer of compensation liquid 16 while the system 10 is in operational modes and is not in direct communication with the gas layer 14. In the illustrated example, the lower wall 15 is planar and is generally horizontal (parallel to plane 19, or optionally arranged to have a maximum grade of between about 0.01% to about 1%, and optionally between about 0.5% and about 1%, from horizontal), and the lower/inner end 64 of the liquid supply conduit 40 is placed close to the lower wall 15. If the lower wall 15 is not flat or not generally horizontal, the lower/inner end 64 of the liquid supply conduit 40 is preferably located in a low point of the accumulator 12 to help reduce the chances of the lower/inner end 64 being exposed to the gas layer 14.

Similarly, to help facilitate extraction of gas from the gas layer when in a discharging mode, the lower end 62 of the gas conduit 22 is preferably located close to the upper wall 13, or if the upper wall 13 is not flat or generally horizontal at a high-point in the interior 23 of the accumulator 12. This may help reduce material trapping of any gas in the accumulator 12. For example, if the upper wall 13 were oriented on a grade, the point at which gas conduit 22 interfaces with the gas layer (i.e. its lower end 62) should be at a high point in the accumulator 12, to help avoid significant trapping of gas.

Preferably, as will be described, the pressure at which the quantity of compensation liquid 20 bears against bulkhead 24 and can be maintained so that magnitude of the counter force 46 is as equal, or nearly equal, to the magnitude of the internal accumulator force 41 exerted by the compressed gas in compressed gas layer 14 stored in accumulator 12. In the illustrated embodiment, operating system 10 so as to maintain a pressure differential (i.e. the difference between gas pressure inside the accumulator 12 and the hydrostatic pressure at the lower end 43 of the shaft 18) within a threshold amount—an amount preferably between 0 and 4 Bar, such as 2 Bar—the resulting net, partition force acting on the bulkhead 24 (i.e. the difference between the internal accumulator force 41 and the counter force 46) can be maintained below a pre-determined threshold partition force limit.

In this embodiment, a gas conduit 22 is provided to convey compressed air between the compressed gas layer 14 and the compressor/expander subsystem 100, which can convert compressed air energy to and from electricity. Similarly, a liquid conduit 40 is configured to convey water between the layer of compensation liquid 16 and the compensation liquid 20 in shaft 18. Each conduit 22 and 40 may be formed from any suitable material, including metal, plastic and the like.

FIG. 2 is a schematic view of components of one example of a compressor/expander subsystem 100 for the compressed gas energy storage system 10 described herein. In this example, the compressor/expander subsystem 100 includes a compressor 112 of single or multiple stages, driven by a motor 110 that is powered, in one alternative, using electricity from a power grid G or by a renewable power source or the like, and optionally controlled using a suitable controller 118. Compressor 112 is driven by motor 110 during a compression mode of operation, and draws in atmospheric air A, compresses the air, and forces it down into gas conduit 22 for storage in accumulator 12. Compressor/expander subsystem 100 also includes an expander 116 driven by compressed air exiting from gas conduit 22 during an expansion mode of operation and, in turn, driving generator 114 to generate electricity. After driving the expander 116, the expanded air is conveyed for exit to the atmosphere A. While shown as separate apparatuses, the compressor 112 and expander 116 may be part of a common apparatus, as can a hybrid motor/generator apparatus. Optionally, the motor and generator may be provided in a single machine.

Air entering or leaving compressor and expander subsystem 100 may be conditioned prior to its entry or exit. For example, air exiting or entering compressor/expander subsystem 100 may be heated and/or cooled to reduce undesirable environmental impacts or to cause the air to be at a temperature suited for an efficient operating range of a particular stage of compressor 112 or expander 116. For example, air (or other gas being used) exiting a given stage of a compressor 112 may be cooled prior to entering a subsequent compressor stage and/or the accumulator 12, and/or the air may be warmed prior to entering a given stage of an expander 116 and may be warmed between expander stages in systems that include two or more expander stages arranged in series.

Controller 118 operates compressor/expander subsystem 100 so as to switch between compression and expansion modes as required, including operating valves for preventing or enabling release of compressed air from gas conduit 22 on demand.

Optionally, the system 10A may include a thermal storage subsystem that is configured to transfer heat/thermal energy out of and preferably also into the gas flowing through the gas flow path between the accumulator and the compressor/expander subsystem 100. Preferably, the thermal storage subsystem is configured to extract thermal energy from the gas exiting at least one of the one or more compression stages in a given compressor/expander subsystem 100, and preferably being configured to extract heat from the gas exiting each compression stage 112. The extracted thermal energy can then be stored for a period of time, and then reintroduced into the gas as it is removed from the accumulator 12 and passed through one or more expanders 116.

The solid material that is used in the slurry that provides the compensation liquid may be any suitable material that is more dense than the carrier liquid (preferably water) and that can be suitably mixed/entrained with the carrier liquid so as to remain suspended in the slurry for a desired length of time without settling out of the slurry. Some examples of suitable solid materials can include clays, ores, sand, rocks, magnetite, limestone, iron ore, copper concentrate and the like and/or mixtures of two or more different materials.

Preferably, the slurries described herein can be configured using solid materials that can remain in suspension for a relatively long time without movement, or agitation of the slurry. This may help reduce the likelihood of separation of the solids from the slurry during system operation. For example, if the system is configured to store the compressed gas for 4, 6, 8, 10, 12, 14, 16, 24 hours or more, or possibly several days or weeks, then portions of the compensation liquid, including that within the shaft and accumulator, may remain generally still during much of that storage time. This may tend to promote settling of the solid particles out of the slurry, which could lead to fouling of the system and/or to changes in the operating or accumulator pressures of the system as reductions in density of the slurry would reduce its hydrostatic pressure. Preferably, the slurry is configured so that the solids, or at least an acceptable retained portion of the solids, such as at least about 90% of the solid particles, can remain in suspension in the slurry for a period of time that is generally equal to or greater than the anticipated storage times of a given system, and may be greater than 4, 6, 8, 10, 12, 14, 16, 24 hours or more, and may be more than 1, 2, 3, 4, 5, 6, 7 or more or weeks.

Preferably, the slurry is configured using solid materials that are alone, and when mixed with the carrier liquid/water are generally chemically benign. This may help prevent unwanted chemical reactions within the system, which could contribute to oxidation or damage to system components, or the formation of unwanted gas or the like.

The slurries used in the systems described herein are preferably at least substantially homogeneous, so that the compensation liquid exhibits generally consistent and predictable properties while in use.

FIG. 3 is a schematic representation of another example of a compressed gas energy storage system 10B. The compressed gas energy storage system 10B is analogous to the compressed gas energy storage system 10A, and like features are identified using like reference characters. In this example, the partition separating the interior of the accumulator 12 from the compensation shaft 18 at includes a projection 200A, identified using cross-hatching in FIG. 3, that is formed from generally the same material as the surrounding ground 200. In this example, the system 10B need not include a separately fabricated bulkhead 24 as shown in other embodiments. To help provide liquid communication between the interior of the shaft 18 and the layer of compensation liquid 16, a liquid supply conduit 40 can be provided to extend through the projection 200A or, as illustrated, at least some of the liquid supply conduit 40 can be provided by a flow channel that passes beneath the projection 200A and fluidly connects the shaft 18 to the layer of compensation liquid 16, and in ends 64 and 66 of the liquid supply conduit 40 can be the open ends of the passage.

Optionally, in such embodiments the gas supply conduit 22 may be arranged to pass through the partition/projection 200A as illustrated in FIG. 3. In this arrangement, the conduit 22 can be configured so that its end 62 is positioned toward the upper side of the accumulator 12 to help prevent the layer of compensation liquid 16 reaching the end 62. Alternatively, the gas supply conduit 22 need not pass through the partition, as schematically illustrated using dashed lines for alternative conduit 22.

A thermal storage subsystem, including any can be used in combination with an accumulator 12 having this arrangement. Some examples of suitable thermal storage subsystem are described in PCT/CA2018/050112 and PCT/CA2018/050282, which are incorporated herein by reference.

When the accumulator 12 is in use, at least one of the pressurized gas layer 14 and the layer of compensation liquid 16, or both, may contact and exert pressure on the inner surface 29 of the partition 200A, which will result in a generally outwardly, (rightward in this embodiment) acting internal accumulator force, represented by arrow 41 in FIG. 3, acting on the partition 200A. The magnitude of the internal accumulator force 41 is dependent on the pressure of the gas 14/liquid 16 and the cross-sectional area of the inner surface 29. For a given inner surface 29 area, the magnitude of the internal accumulator force 41 may vary generally proportionally with the pressure of the gas 14 and/or compensation liquid 16.

Preferably, an inwardly, (leftward in this embodiment) acting force can be applied to the outer surface 31 of the partition 200A, via the hydrostatic pressure of the compensation liquid, to help offset and/or counterbalance the internal accumulator force 41. Applying a hydrostatic counter force of this nature may help reduce the net partition force acting on the partition 200A while the system 10 is in use.

In the present embodiment, the system 10 includes a shaft 18 having a lower end 43 that is in communication with the opening 27 in the lower wall 15 of the accumulator 12, and an upper end 48 that is spaced apart from the lower end 43 by the shaft height (which corresponds to the accumulator depth 50 in this example). At least one sidewall 52 extends from the lower end 43 to the upper end 48, and at least partially defines a shaft interior 54 having a volume. In this embodiment, the shaft 18 is generally linear and extends along a generally vertical shaft axis, but may have other configurations, such as a linear or helical decline, in other embodiments. The upper end 48 of the shaft 18 may be open to the atmosphere A, as shown, or may be capped, enclosed or otherwise sealed. In this embodiment, shaft 18 is generally cylindrical with a diameter of about 3 metres, and in other embodiments the diameter may be between about 2 m and about 15 m or more, or may be between about 5 m and 12 m, or between about 2 m and about 5 m. In such arrangements, the interior 52 of the shaft 18 may be able to accommodate about 1,000-150,000 m3 of water or other suitable compensation liquid.

FIG. 4 is a schematic illustration of another example of a hydrostatically compensated compresses gas energy storage system 10C, which is analogous to system 10A and like features are illustrated using like reference characters.

While water-based slurries are preferable for use with the systems described herein, because, for example, they may be relatively lower cost and may pose relatively lower risks to the environment, however, slurries that are not water based (such as slurries that use oil or other liquids) may be used in some embodiments of the teachings described herein.

References to compensation liquid and other such terms herein are intended to also include the use of a compensation slurry as described herein or other non-gaseous, generally flowable fluids, such as solutions, mixtures and the like that have properties that could make it suitable for use in the systems described.

What has been described above has been intended to be illustrative of the invention and non-limiting and it will be understood by persons skilled in the art that other variants and modifications may be made without departing from the scope of the invention as defined in the claims appended hereto.

1. A hydrostatically compensated, compressed gas energy storage system comprising:
a) an accumulator disposed underground and comprising an interior for containing a layer of compressed gas above a layer of compensation liquid, the layer of compressed gas being at an accumulator pressure that is between about 20 bar and about 90 bar and the compensation liquid having a density of at least 1500 kg/m³;
b) a compressor and expander subsystem in fluid communication with the accumulator interior via a gas flow path and configured to selectably convey compressed gas into the accumulator and to extract gas from the accumulator;
c) a compensation liquid reservoir spaced apart from the accumulator and a compensation liquid flow path extending between the compensation liquid reservoir and the layer of compensation liquid within the accumulator; and
the system being operable in at least a charging mode in which the compressor and expander subsystem conveys gas into the layer of compressed gas thereby displacing a corresponding volume of compensation liquid from the layer of compensation liquid within the accumulator out of the accumulator via the compensation liquid flow path thereby maintaining the layer of compressed gas at substantially the accumulator pressure during the charging mode.

2. The system of claim 1, wherein the system is operable in a discharging mode in which the compressor and expander subsystem extracts gas from the layer of compressed gas as a corresponding volume of compensation liquid flows from compensation liquid flow path into the layer of compensation liquid within the accumulator thereby maintaining the layer of compressed gas at substantially the accumulator pressure during the discharging mode.

3. The system of claim 1, wherein the compensation liquid is a slurry comprising solid particles suspended in water.

4. The system of claim 3, wherein the solid particles comprise particles formed from at least one of clay, ore, sand, rocks, magnetite, limestone, iron ore, copper concentrate.

5. The system of claim 4, wherein the solid particles comprise one of magnetite, limestone, iron ore, and copper concentrate.

6. The system of claim 3, wherein at least 90% of the solid particles remain in suspension in the water for at least 12 hours.

7. The system of claim 6, wherein at least 90% of the solid particles remain in suspension in the water for at least 48 hours.

8. The system of claim 6, wherein at least 90% of the solid particles remain in suspension in the water for at least 1 week.

9. The system of claim 1, wherein the compensation liquid density is less than 2400 kg/m3.

10. The system of claim 1, further comprising an agitating system configured to agitate the compensation liquid within the compensation liquid reservoir to help keep solid particles suspended in water.

11. The system of claim 1, wherein the accumulator pressure is at least 50 bar.

12. The system of claim 1, wherein the accumulator is disposed at an accumulator depth that is between about 200 m and about 700 m.

13. The system of claim 12, wherein the accumulator depth is less than 500 m.

14. The system of claim 1, wherein:
a) the compensation liquid flow path comprises a shaft having a lower end adjacent the accumulator, an upper end spaced apart from the lower end, and a shaft sidewall extending upwardly from the lower end to the upper end and at least partially bounding a shaft interior containing a quantity of the compensation liquid, the shaft interior being fluidly connected to the compensation liquid reservoir; and
b) further comprising a partition separating an interior of the accumulator from the shaft interior, the partition having an outer surface in contact with the quantity of compensation liquid within the shaft interior and an opposing inner surface in contact with the layer of compressed gas and the layer of compensation liquid,
whereby at least one of the layer of compressed gas and the layer of compensation liquid bears against and exerts an internal accumulator force on the inner surface of the partition and the quantity of liquid within the shaft bears against and exerts an external hydrostatic counter force on the outer surface of the partition, so that a partition force acting on the partition while the compressed gas energy storage system is in use is a difference between the accumulator force and the hydrostatic counter force and is less than the accumulator force.

15. The system of claim 14, wherein the shaft interior is fluidly connected to the layer of compensation liquid by a liquid supply conduit so that the compensation liquid can flow between the shaft interior and the layer of liquid in the accumulator in response to changes in the pressure of the layer of compressed gas.

16. The system of claim 15, wherein the liquid supply conduit passes thorough the partition or beneath the partition.

17. The system of claim 14, wherein a liquid supply conduit extends between a first end that is proximate the outer surface of the partition and is in fluid communication with the shaft and a second end that is in communication with the layer of compensation liquid and remains fluidly isolated from the layer of gas when the compressed gas energy storage system is in use.

18. The system of claim 1, wherein the gas flow path comprises a gas supply conduit configured to convey compressed gas between the layer of compressed gas and the compressor and expander subsystem, and wherein at least a portion of an outer surface of the gas supply conduit is in contact with the compensation liquid in the compensation liquid flow path.

19. The system of claim 18, wherein the gas supply conduit passes through a partition.

20. The system of claim 1, wherein the gas flow path comprises a gas supply conduit that is external to the liquid flow path and is configured to convey compressed gas between the layer of compressed gas and the compressor and expander subsystem.
